(19) United States
(12) Patent Application Publication
(10) Pub. No.: US 2022/0279780 A1
(43) Pub. Date: Sep. 8, 2022

(54) AGRICULTURAL FORMULATION

(71) Applicant: ISHIHARA SANGYO KAISHA, LTD., Osaka (JP)

(72) Inventors: Mitsuo SANO, Osaka (JP); Takao AWAZU, Osaka (JP); Takashi OKADA, Osaka (JP); Yutaka ISHIBASHI, Osaka (JP); Yusuke KOBAYASHI, Osaka (JP)

(73) Assignee: ISHIHARA SANGYO KAISHA, LTD., Osaka (JP)

(21) Appl. No.: 17/630,404

(22) PCT Filed: Jul. 27, 2020
(86) PCT No.: PCT/JP2020/028744

§ 371 Date: Jan. 26, 2022

(30) Foreign Application Priority Data
Aug. 5, 2019 (JP) 2019-143474

(51) Int. Cl. A01N 25/04; A01N 25/02; A01N 25/30

(52) U.S. Cl. CPC A01N 25/04; A01N 25/02; A01N 25/30

(57) ABSTRACT

In order that an agriculturally active ingredient, particularly a water-insoluble or water-hardly soluble agriculturally active ingredient sufficiently exerts its effects, it is used preferably in the form of an agricultural formulation having the agriculturally active ingredient dissolved, particularly a clear agricultural formulation having not only the agriculturally active ingredient but also other components contained in the agricultural formulation dissolved. When the agricultural formulation is practically used, if foaming when diluted with water is intense, foam may overflow from a tank in which the solution is prepared. A clear agricultural formulation having the agriculturally active ingredient dissolved and further other components contained in the agricultural formulation dissolved, and its foaming when diluted with water suppressed, is required. An agricultural formulation includes an agriculturally active ingredient (a), a surfactant (b), a silicone compound (c) represented by formula (I) and an organic solvent (d), wherein (a), (b) and (c) are dissolved in (d).

### TECHNICAL FIELD

The present invention relates to an agricultural formulation. More particularly, it relates to an agricultural formulation having an agriculturally active ingredient dissolved therein, and its foaming when diluted with water suppressed.

### BACKGROUND ART

Heretofore, an agricultural formulation having an agriculturally active ingredient particularly a water-insoluble or water-hardly soluble agriculturally active ingredient dissolved has been studied (Patent Documents 1 and 2). Such an agricultural formulation usually contains an agriculturally active ingredient and a solvent in which the agriculturally active ingredient is dissolved, and in addition, a surfactant for the purpose of e.g. solubilizing and/or enhancing the effect of the agriculturally active ingredient, and stabilizing the agricultural formulation. Further, to register agricultural chemicals, requirements specified for the respective formulation types must be met, for example, an agricultural formulation having not only an agriculturally active ingredient but also other components contained in the agricultural formulation dissolved in a solvent, is required to be clear.

An agricultural formulation is usually diluted with water when used and applied to plants or to a place where they grow. In a case were the agricultural formulation contains a surfactant, where the agricultural formulation is diluted with water, foam is likely to form, and particularly in a case where the agriculturally active ingredient is water-insoluble or water-hardly soluble, the content of the surfactant increase and possibility of foaming also increases. Therefore, when the agricultural formulation is diluted with water, a defoaming agent may be added, or the agricultural formulation itself may contain a defoaming agent, and considering convenience to the user, it is preferred that the agricultural formulation itself contains a defoaming agent. Further, in an agricultural formulation having an agriculturally active ingredient dissolved, it is preferred that the defoaming agent is also dissolved, so as to keep uniformity of the agricultural formulation.

As the defoaming agent to be used for the agricultural formulation, a silicone defoaming agent (for example, a silicone oil, a modified silicone oil, or a silicone oil containing a filer such as silica) may, for example, be mentioned. For example, Patent Document 3 discloses a composition containing a polyoxyalkylene-modified organopolysiloxane to be used as an agricultural adjuvant and a glycerin-modified organopolysiloxane as a component to suppress foaming resulting from the polyoxyalkylene-modified organopolysiloxane. Further, Patent Document 4 discloses a composition further containing a polyoxyalkylene/perfluoroalkyl co-modified organopolysiloxane, as the composition disclosed in Patent Document 3 is insufficient in the ability to eliminate already existing foam. However, neither Patent Document 3 nor 4 relates to an agricultural formulation having an agriculturally active ingredient dissolved an organic solvent.

### PRIOR ART DOCUMENTS

### Patent Documents

Patent Document 1:WO92/010937

Patent Document 2: WO2009/113712

Patent Document 3: JP-A-2005-336266

Patent Document 4: JP-A-2008-169176

### DISCLOSURE OF INVENTION

### Technical Problem

In order that an agriculturally active ingredient, particularly a water-insoluble or water-hardly soluble agriculturally active ingredient sufficiently exerts its effects, it is used preferably in the form of an agricultural formulation having the agriculturally active ingredient dissolved therein, particularly a clear agricultural formulation having not only an agriculturally active ingredient but also other components contained in the agricultural formulation dissolved. Further, when the agricultural formulation is practically used, if foaming when diluted with water is intense, foam may overflow from a tank in which a liquid to be applied, is prepared. Accordingly, a clear agricultural formulation having an agriculturally active ingredient dissolved and further other components contained in the agricultural formulation dissolved, thereby its foaming when diluted with water suppressed, is required.

### Solution to Problem

The present invention provides an agricultural formulation comprising an agriculturally active ingredient (a), a surfactant (b), a silicone compound (c) represented by the following formula (I) (hereinafter sometimes referred to simply a “silicone compound (c)”) and an organic solvent (d), wherein (a), (b) and (c) are dissolved in (d):

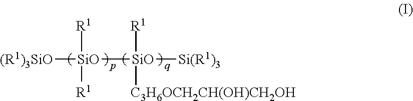

wherein R¹ are each independently a C₁₋₂₀ alkyl group, p is an integer of from 0 to 3, and q is an integer of from 1 to 2.

The present invention further provides a method for suppressing foaming of a water-dilution of an agricultural formulation comprising an agriculturally active ingredient (a), a surfactant (b), a silicone compound (c) and an organic solvent (d), by dissolving the silicone compound (c) in a mixture comprising the active ingredient (a), the surfactant (b) and the organic solvent (d), and use of a silicone compound (c) to suppress foaming of a water-dilution of an agricultural formulation comprising an agriculturally active ingredient (a), a surfactant (b), the silicone compound (c) and an organic solvent (d), by dissolving the silicone compound (c) in a mixture comprising the active ingredient (a), the surfactant (b) and the organic solvent (d). The present invention further relates to a combination of a surfactant (b), a silicone compound (c) and an organic solvent (d) in production of an agricultural formulation having an agriculturally active ingredient (a) dissolved, particularly a clear agricultural formulation having not only an agriculturally active ingredient (a) but also other components contained in the agricultural formulation dissolved.

### Advantageous Effects of Invention

According to the present invention, an agricultural formulation by which the agriculturally active ingredient sufficiently exerts its effects and of which foaming when diluted with water is suppressed, at the time of use of the agricultural formulation, is provided.

### DESCRIPTION OF EMBODIMENTS

The agricultural formulation of the present invention comprises an agriculturally active ingredient (a), a surfactant (b), a silicone compound (c) and an organic solvent (d), and is characterized in that the agriculturally active ingredient (a), the surfactant (b) and the silicone compound (c) are dissolved in the organic solvent (d).

The agricultural formulation of the present invention preferably has a form of a clear liquid (that is free from visible suspended matter and sediment) in which all components contained are uniformly dissolved, more preferably the form which meets international guidelines, for example, CropLife International (CLI), The Food and Agricultural Organization of the United Nations (FAO), World Health Organization (WHO) and Organization for Economic Co-operation and Development (OECD), and domestic guideline.

More particularly, the agricultural formulation of the present invention having a form of a clear liquid, has a transmittance to light at a wavelength in a visible region of usually at least 94%, preferably at least 95%, more preferably at least 97%, further preferably at least 99%. The wavelength at which the transmittance is measured may properly be selected depending upon e.g. the color of the agricultural formulation to be measured, and is, for example, from 590 to 750 nm, preferably from 600 to 700 nm, more preferably 660 nm.

More specifically, the transmittance to light is a transmittance from the absorbance of the agricultural formulation measured with respect to light at the above wavelength by an ultraviolet visible spectrometer (for example, UV-2550 (manufactured by Shimadzu Corporation)) (temperature: room temperature, optical path length: 100 mm, quartz cell volume: 3.7 mL), in accordance with the following formula. The measured value of the transmittance may sometimes vary by the type of the blank, and for example, as a blank, water, an alcohol or an agricultural formulation containing the agriculturally active ingredient (a), the surfactant (b) and the organic solvent (d) may be used, and preferably, an agricultural formulation containing the agriculturally active ingredient (a), the surfactant (b) and the organic solvent (d) may be used as a blank.

Transmittance=10^{(absorbance)}×100

The agricultural formulation of the present invention may be formed into any optional liquid formulation type employed in this technical field, so long as the agriculturally active ingredient (a), the surfactant (b) and silicone compound (c) are dissolved in the organic solvent (d). More particularly, the agricultural formulation of the present invention may be formulated into a formulation type having a form of a clear liquid in which all components contained in the agricultural formulation are uniformly dissolved, such as SL (soluble concentrate), DC (dispersible concentrate), ME (microemulsion), LS (Solution for seed treatment) or AL (other liquids to be applied undiluted), particularly preferably SL (soluble concentrate), DC (dispersible concentrate) or ME (microemulsion).

The combination of the surfactant (b), the silicone compound (c) and the organic solvent (d) of the present invention may, as described in the after-mentioned Examples, be applicable to agriculturally active ingredients (a) having various solubilities and activities. Accordingly, in the present invention, the agriculturally active ingredient (a) is not limited in terms of its solubility, activity, etc., and any agriculturally active ingredient known in this technical field, for example, one or more (for example one, two, three or four) agriculturally active ingredients selected from the group consisting of herbicides, insecticides, fungicides and plant growth regulators may be used. More particularly, as the agriculturally active ingredient (a), for example, agriculturally active ingredients listed in “The Pesticide Manual” (eighteenth Edition, The British Crop Protection Council, 2018), and “Pesticide Handbook” (Japan Plant Protection Association, 2016) may be used. Further, the agriculturally active ingredient (a) of the present invention includes agriculturally active ingredients under development or to be developed in future.

Preferred specific examples of the agriculturally active ingredient (a) include, although not limited to the following:

herbicides such as aryloxypropionate compounds, imidazolinone compounds, urea compounds, oxazolidinedione compounds, oxyacetamide compounds, carbamate compounds, cafenstrole, cumyluron, glycine compounds, chloroacetamide compounds, diphenyl ether compounds, sulfonylurea compounds, daimuron, thiocarbamate compounds, triketone compounds, triazolinone compounds, triazine compounds, bipyridylium compounds, pyridinecarboxylic acid compounds, pyrachlonil, pyrazole compounds, pyributicarb, phenylpyridazine compounds, phenoxycarboxylic acid compounds, bromobutide, pelargonic acid, benzofuran compounds, benzoylpyrazole compounds, benzothiadiazinone compounds, phosphinic acid compounds; and

insecticides such as avermectin compounds, chloropicrin, diamide compounds, spinosyn compounds, semicarbazone compounds, pyrethroid compounds, pyrethrin compounds, pyridine azomethine derivative compounds, phenylpyrazole compounds, buprofezin, flonicamid, benzoylurea compounds, neonicotinoid compounds, pyriproxyfen, and organophosphorus compounds; and

fungicides such as acylalanine compounds, anilinopyrimidine compounds, isoxazole compounds, imidazole compounds, imidazolinone compounds, ethylamino thiazole carboxamide compounds, oxyimino acetamide compounds, carbamate compounds, guanidine compounds, chloronitrile compounds, cinnamic acid amide compounds, cyanoacetamide oxime compounds, cyanoimidazole compounds, dithiocarbamate compounds, 2,6-dinitroaniline compounds, thiophanate compounds, triazole compounds, triazolinethione compounds, toluamide compounds, valinamide carbamate compounds, bisguanidine compounds, phenyloxoethyl thiophenamide compounds, phenylpyrrole compounds, phthalimide compounds, benzoylpyridine compounds, peptidylpyrimidine nucleotide compounds, benzisothiazole compounds, phosphonate compounds, methoxyacrylate compounds, and methoxyacetamide compounds.

More preferred specific examples include:

herbicides such as pyrazole compounds (such as tolpyralate), sulfonylurea compounds (such as nicosulfuron, flazasulfuron and flucetosulfuron), aryloxypropionate compounds (such as fluazifop-P), phenoxycarboxylic acid compounds (such as 2,4-PA-ethyl), and triketone compounds (such as lancotrione);

insecticides such as diamide compounds (such as cyclaniliprole, chlorantraniliprole, cyantraniliprole and flubendiamide), flonicamid, benzoylurea compounds (such as chlorfluazuron), organophosphorus compounds (such as fosthiazate, chlorpyrifos, cadusafos and imicyafos), pyrethroid compounds (such as gamma-cyhalothrin, bifenthrin, beta-cyhalothrin and silafluofen), neonicotinoid compounds (such as imidacloprid, acetamiprid and thiamethoxam), carbamate compounds (such as methomyl, oxamyl, carbofuran and carbosulfan), and avermectin compounds (such as abamectin and emamectin benzoate); and

fungicides such as cyanoimidazole compounds (such as cyazofamid), 2,6-nitroaniline compounds (such as fluazinam), phenyloxoethyl thiophenamide compounds (such as isofetamid), benzoylpyridine compounds (such as pyriofenone), bisguanidine compounds (such as iminoctadine albesilate), imidazole compounds (such as triflumizole), polyoxins.

The present invention is particularly useful for a water-insoluble or water-hardly soluble agriculturally active ingredient which may cause a problem with exertion of the effects of the agriculturally active ingredient (a), from the viewpoint of exertion of the effects of the agriculturally active ingredient (a). The water-insoluble or water-hardly soluble agriculturally active ingredient means an agriculturally active ingredient which is not soluble in water or has a solubility in water at 20° C. of usually at most 10 ppm, particularly at most 1 ppm.

The content of the agriculturally active ingredient (a) in the agricultural formulation is not particularly limited so long as the agriculturally active ingredient (a) is dissolved in the agricultural formulation. For example, the content of the agriculturally active ingredient (a) in the agricultural formulation is usually from 0.1 to 40 wt %, preferably from 0.1 to 30 wt %, more preferably from 0.1 to 20 wt %. In a case where two or more agriculturally active ingredients (a) are contained, the content means the total content of the two or more agriculturally active ingredients (a).

In the present invention, as described in the after-mentioned Examples, surfactants (b) having various structures and properties may be used. Accordingly, in the present invention, the surfactant (b) is not limited in terms of its structure, properties, etc., and any surfactant known in this technical field, for example, one or more (for example one, two, three or four) surfactants selected from the group consisting of nonionic surfactants, anionic surfactants, cationic surfactants and ampholytic surfactants may be used. Particularly, the surfactant (b) is preferably one or more surfactants selected from nonionic surfactants and anionic surfactants.

Specific examples of the surfactant include:

nonionic surfactants such as a polyoxyalkylene surfactant, a block copolymer surfactant and a polyhydric alcohol surfactant;

anionic surfactants such as a sulfonate surfactant, a sulfate ester surfactant, a phosphate ester surfactant and a carboxylate surfactant;

cationic surfactants such as an amine salt surfactant and an ammonium salt surfactant;

ampholytic surfactants such as a betaine surfactant and an amine oxide surfactant; and

amino acid surfactants.

Among the surfactants (b), preferred specific examples of the nonionic surfactant and the anionic surfactant are listed below.

Polyoxyalkylene surfactants: polyoxyalkylene alkyl ether, polyoxyalkylene aryl ether, polyoxyalkylene alkyl aryl ether, polyoxyalkylene aryl aryl ether, polyoxyalkylene styryl phenyl ether, a polymer of polyoxyalkylene styryl phenyl ether, polyoxyalkylene resinate, polyoxyalkylene fatty acid ester, polyoxyalkylene sorbitan fatty acid ester, polyoxyalkylene sorbitol fatty acid ester, polyoxyalkylene glycerol fatty acid ester, polyoxyalkylene castor oil, polyoxyalkylene hydrogenated castor oil, polyoxyalkylene alkylamine, polyoxyalkylene fatty acid amide, polyoxyalkylene dimethylsiloxane, etc. The polyoxyalkylene moiety in such compounds may be polyoxyethylene or polyoxypropylene, and the fatty acid moiety may be C₈₋₁₈ one. The aryl may be mono-, di- or tri-substituted.

Block copolymer surfactants: polyoxyethylene polyoxypropylene block copolymer, polyoxyethylene polyoxypropylene block copolymer alkyl ether, polyoxyethylene polyoxypropylene block copolymer alkyl phenyl ether, etc. The alkyl moiety in such compounds may be C₈₋₁₂ one.

Sulfonate surfactants: sulfonates and their salts, such as alkyl sulfonate, alkene sulfonate, alkyne sulfonate, aryl sulfonate, alkyl aryl sulfonate, aryl sulfonate condensed with formalin, alkyl aryl sulfonate condensed with formalin, α-olefin sulfonate, dialkylsulfosuccinate, lignin sulfonate, polyoxyethylene alkyl ether sulfosuccinate half ester, creosote oil sulfonate condensed with formalin, alkyl diphenyl ether disulfonate, polystyrene sulfonate, a copolymer of styrene sulfonate and methacrylic acid, etc. The alkyl moiety and the olefin moiety in such compounds are C₈₋₂₂ ones, and as the salt, alkali metal salts such as sodium salt and potassium salt, alkaline earth metal salts such as calcium salt, and ammonium salts may, for example, be mentioned. The aryl includes mono-, di- and tri-substituted aryls.

Sulfate ester surfactants: sulfate esters and their salts, such as alkyl sulfate ester, polyoxyethylene alkyl sulfate ester, polyoxyethylene alkyl ether sulfate ester, polyoxyethylene alkyl aryl ether sulfate ester, polyoxyethylene aryl aryl ether sulfate ester, polyoxyethylene styryl phenyl ether sulfate ester, a sulfate ester of a polyoxyethylene polyoxypropylene block copolymer, sulfated oil, sulfated fatty acid ester, sulfated fatty acid, sulfated olefin, etc. The alkyl moiety in such compounds may be C₈₋₁₈ one, and as the salt, alkali metal salts such as sodium salt and potassium salt, alkaline earth metal salts such as calcium salt, and ammonium salts may, for example, be mentioned. The aryl includes mono-, di- and tri-substituted aryls.

Phosphate ester surfactants: alkyl phosphate ester, polyoxyethylene alkyl phosphate ester, polyoxyethylene alkyl ether phosphate ester, polyoxyethylene alkyl phenyl ether phosphate ester, polyoxyethylene styryl phenyl ether phosphate ester, and their salts. The alkyl moiety in such compounds may be C₈₋₁₈ one, and as the salt, alkali metal salts such as sodium salt and potassium salt, alkaline earth metal salts such as calcium salt, and ammonium salts may, for example, be mentioned.

Carboxylate surfactants: fatty acid, metal soap, alkyl ether carboxylate, acyl lactate, N-acyl amino acid, polycarboxylic acid, and their salts. The alkyl moiety in such compounds may be C₈₋₁₈ one, and as the salt, alkali metal salts such as sodium salt and potassium salt, alkaline earth metal salts such as calcium salt, and ammonium salts may, for example, be mentioned.

Among the surfactants (b), more preferred specific examples of the nonionic surfactant and the anionic surfactant are listed below.

Polyoxyalkylene surfactants: polyoxyalkylene alkyl ether (such as polyoxyethylene alkyl ether), polyoxyalkylene alkyl aryl ether (such as polyoxyethylene alkyl aryl ether), polyoxyalkylene styryl phenyl ether (such as polyoxyethylene styryl phenyl ether), polyoxyalkylene castor oil (such as polyoxyethylene castor oil), polyoxyalkylene fatty acid ester (such as polyoxyethylene fatty acid ester), polyoxyalkylene sorbitan fatty acid ester (such as polyoxyethylene sorbitan fatty acid ester), polyoxyalkylene sorbitol fatty acid ester (such as polyoxyethylene sorbitol fatty acid ester), polyoxyalkylene dimethylsiloxane (such as polyoxyethylene dimethylsiloxane), etc.;

block copolymer surfactants: polyoxyethylene polyoxypropylene block copolymer, etc.;

sulfonate surfactants: alkylaryl sulfonate or its salt (such as calcium alkylbenzenesulfonate), aryl sulfonate or its salt, alkyl sulfonate or its salt, lignin sulfonate or its salt, alkyl sulfosuccinate or its salt, etc.:

sulfate ester surfactants: alkyl sulfate ester or its salt (such as sodium lauryl sulfate), polyoxyethylene styryl phenyl ether sulfate ester or its salt (such as polyoxyethylene styryl phenyl ether sulfate), polyoxyethylene alkyl sulfate ester or its salt (such as polyoxyethylene alkyl sulfate), etc.;

phosphate ester surfactants: alkyl phosphate ester, polyoxyethylene alkyl ether phosphate ester, polyoxyethylene alkyl phosphate ester, polyoxyethylene styryl phenyl ether phosphate ester, etc.;

carboxylate surfactants: fatty acid, metal soap, alkyl ether carboxylate, N-acyl amino acid, polycarboxylic acid, etc.

Further, as the surfactant (b), amine salt surfactants (such as polyoxyethylene tallow amine), amino acid surfactants: N-acyl amino acid salt (such as N-coconut oil fatty acid acyl-L-glutamic acid triethanolamine) are also preferred.

Examples of commercial products of the respective surfactants (b) are listed below. In the following Table, TOHO: TOHO Chemical Industry Co., Ltd., DAIICHI:DKS Co. Ltd., ASAHI: ASAHI KASEI FINECHEM CO., LTD., and NIKKO: Nikko Chemicals Co., Ltd.

TABLE A

| Type | Component | Tradename |
|---|---|---|
| Polyoxyalkylene | Polyoxyethylene | Rhodasurf 870 (SOLVAY) |
| surfactant | alkyl ether | Synperonic 810 (CRODA) |
| | | Brij C20 (CRODA) |
| | | Synergen W 06 (CLARIANT) |
| | | Genapol C 100 (CLARIANT) |
| | | NOIGEN SD-70 (DAIICHI) |
| | Polyoxyethylene | Atlox 775 (CRODA |
| | alkyl aryl ether | Sapogenat T130 (CLARIANT) |
| | Polyoxyethylene | Soprophor BSU (SOLVAY) |
| | styryl | Emulsogen TS 200 (CLARIANT) |
| | phenyl ether | Sorpol T-20 (TOHO) |
| | | NOIGEN EA-7 (DAIICHI) |
| | Polyoxyethylene | Alkamuls OR/36 (SOLVAY) |
| | castor oil | Atlox 3484 (CRODA) |
| | | Etocas 10 (CRODA) |
| | | Sorpol CA30 (TOHO) |
| | Polyoxyethylene | AgRho EM 63 (SOLVAY) |
| | fatty acid ester | Emulsogen EL 200 (CLARIANT) |
| | Polyoxyethylene | Alkamuls T/80 (SOLVAY) |
| | sorbitan | Tween 80 (CRODA) |
| | fatty acid ester | Emulsogen 4156 (CLARIANT) |
| | Polyoxyethylene | Atlas G-1086 (CRODA) |
| | sorbitol | Arlatone TV (CRODA) |
| | fatty acid ester | |
| | Polyoxyethylene | Silwet L-77 (MOMENTIVE) |
| | dimethylsiloxane | SAG |
| Block copolymer | Polyoxyethylene | Antarox PL/122 (SOLVAY) |
| surfactant | polyoxypropylene | Pluronic PE10500 (BASF) |
| | block | Atlas G-5000 (CRODA) |
| | copolymer | Genapol PF 40 (CLARIANT) |
| | | EPAN 785 (DAIICHI) |

TABLE B

| Type | Component | Tradename |
|---|---|---|
| Sulfonate | Alkyl aryl sulfonate | Rhodacal 60/BE (SOLVAY) |
| surfactant | | Atlox 4838B (CRODA) |
| | | Calsogen 4814 (CLARIANT) |
| | | NANSA SSA (HUNTSMAN) |
| | Aryl sulfonate | Molwet D-425P (AKZO) |
| | | TERSPERSE 2001 (HUNTSMAN) |
| | | RUNOX 1000C (TOHO) |
| | Alkyl sulfonate | MONOGEN Y-100 (DAIICHI) |
| | Lignin sulfonate | Borresperse CA (Borregaard) |
| | Alkyl sulfosuccinate | Multiwet MO-85P (CRODA) |
| | | KOHACOOL (TOHO) |
| | | AIRROL CT-1L (TOHO) |
| Sulfate | Alkyl sulfate ester | TERSPERSE 2218 (HUNTSMAN) |
| ester | | HITENOL LA-16 (DAIICHI) |
| surfactant | | MONOGEN Y-100 (DAIICHI) |
| | Polyoxyethylene | HITENOL PS-15 (DAIICHI) |
| | alkyl sulfate | |
| | Polyoxyethylene styryl | HITENOL NF-13 (DAIICHI) |
| | phenyl ether sulfate | Sorpol T-20SPG (TOHO) |
| Phosphate | Alkyl phosphate ester | Rhodafac ARB/70 (SOLVAY) |
| ester | | Crodafos O10A (CRODA) |
| surfactant | | Hostaphat 1306 (CLARIANT) |
| | Polyoxyethylene alkyl | Rhodafac RS 610E (SOLVAY) |
| | phosphate ester | PHOSPHANOL RS-610 (TOHO) |
| | | Crodafos O3A (CRODA) |
| | Polyoxyethylene styryl | Soprophor FLK (SOLVAY) |
| | phenyl ether phosphate | Dispersogen LFS (CLARIANT) |
| | ester | TERSPERSE 2201 (HUNTSMAN) |
| | | PLYSURF (DAIICHI) |
| Carboxylate | Fatty acid, metal soap | NIKKOL LK-120 POTASSIUM |
| surfactant | | LAURATE (NIKKO) |
| | Alkyl ether carboxylate | NIKKOL AKYPO RLM |
| | | 100 (NIKKO) |
| | Polycarboxylic acid | Geropon T/36 (SOLVAY) |
| | | Dispersogen PSL100 (CLARIANT) |

TABLE C

| | | |
|---|---|---|
| Amino acid | N-Acyl amino acid | AMINOSURFACT |
| surfactant | | ACMT-L (ASAHI) |
| | | NIKKOL SARCOSINATE |
| | | LN (NIKKO) |
| | Lauryl | AMOGEN K (DAIICHI) |
| | dimethylamino | |
| | acetic acid betaine | |
| Amine salt | Polyoxyethylene | Lutensol FA15T (BASF) |
| surfactant | tallow amine | Atlas G-3780 (CRODA) |
| | | Genamin T 100 (CLARIANT) |
| | Polyoxyethylene | Crodaquat 1207 (CRODA) |
| | alkylamine | Genamin C 020 (CLARIANT) |

The content of the surfactant (b) in the agricultural formulation is not particularly limited so long as the agriculturally active ingredient (a) is dissolved in the agricultural formulation. For example, the content of the surfactant (b) in the agricultural formulation is usually from 0.1 to 60 wt %, preferably from 0.1 to 50 wt %, more preferably from 0.1 to 40 wt %. in a case where two or more surfactants (b) are contained, the content means the total content of the two or more surfactants (b).

The silicone compound (c) is a silicone compound represented by the following formula (I):

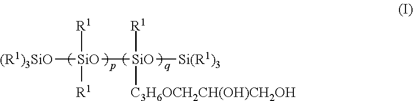

wherein R¹ are each independently a C₁₋₂₀ alkyl group, p is an integer of from 0 to 3, and q is an integer of from 1 to 2.

The silicone compound (c) represented by the formula (I) is preferably compound represented by the following formula (II):

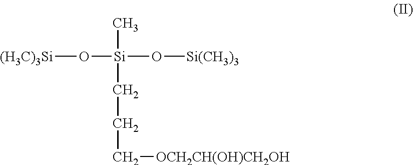

As the silicone compound used as the defoaming agent, various products which can be used in this technical field are commercially available, however, in order to confer defoaming effect, no silicone compound applicable to an agricultural formulation having a form of a clear liquid in which all components contained in the agricultural formulation are uniformed dissolved, has been available, since the main component is a silicone oil which is hardly miscible with the organic solvent or a filler is contained. The present inventors have found that by using the specific silicone compound (c), while the agricultural formulation of the present invention can be made clear, foaming of a water-dilution of the agricultural formulation can be suppressed when diluted with water.

The content of the silicone compound (c) in the agricultural formulation is not particularly limited so long as its effect is obtained and the silicone compound (c) is dissolved in the agricultural formulation. For example, the content of the silicone compound (c) in the agricultural formulation is usually form 0.01 to 10 wt %, preferably from 0.01 to 5 wt %, more preferably from 0.01 to 1 wt %.

The organic solvent (d) is any organic solvent which can be used in this technical field, so long as the agriculturally active ingredient (a), the surfactant (b) and the silicone compound (c) are soluble in it, and the agricultural formulation can be easily diluted with water. The organic solvent (d) may, for example, be an organic solvent miscible with water, such as an amide, a sulfoxide, a ketone, a lactone, a pyrrolidone, an alcohol, an ether or an ester; an organic solvent inferior in miscibility with water, such as an aliphatic ester, an aromatic naphtha or a vegetable oil; or a mixed solvent thereof. Further, so long as the agricultural formulation keeps a form of a clear liquid, the agricultural formulation may contain water, and an organic solvent miscible with water is preferred, whereby the agricultural formulation can be easily diluted with water, and an organic solvent having a water solubility such that the organic solvent is soluble in water in any proportion is particularly preferred.

More preferred specific examples of the organic solvent (d) are listed below.

Amides: N,N-dimethylacetamide, N,N-dimethylformamide, and N,N-dimethyldecanamide;

Pyrrolidones: N-methyl-2-pyrrolidone, N-ethyl-2-pyrrolidone, N-octyl-2-pyrrolidone, and N-butyl-2-pyrollidone;

Sulfoxides: dimethyl sulfoxide;

Ketones: cyclohexanone, acetone, and methyl ethyl ketone;

Lactones: γ-butyrolactone;

Alcohols: propylene glycol, cyclohexanol, n-hexanol, 2-ethylhexanol, tetrahydrofurfuryl alcohol, 2-phenoxyethanol, and polypropylene glycol;

Ethers: propylene glycol monomethyl ether, propylene glycol dimethyl ether, dipropylene glycol monomethyl ether, dipropylene glycol dimethyl ether, tetrahydrofuran, and dioxane;

Esters: dimethyl 2-methylglutarate, and dibasic acid ester.

Among these organic solvents, one or more selected from the group consisting of N,N-dimethylacetamide, N,N-dimethylformamide, N-methyl-2-pyrrolidone, N-octyl-2-pyrrolidone, dimethyl sulfoxide, cyclohexanone, γ-butyrolactone, propylene glycol, cyclohexanol, n-hexanol, tetrahydrofurfuryl alcohol, propylene glycol monomethyl ether, dipropylene glycol monomethyl ether, dipropylene glycol dimethyl ether and dimethyl 2-methylglutarate are more preferred.

The content of the organic solvent (d) in the agricultural formulation is not particularly limited so long as the agriculturally active ingredient (a), the surfactant (b) and the silicone compound (c) are dissolved in the organic solvent (d). For example, the content of the organic solvent (d) in the agricultural formulation is usually form 1 to 99 wt %, preferably from 20 to 99 wt %, more preferably from 40 to 90 wt %. In a case where two or more organic solvents (d) are contained, the content means the total content of the two or more organic solvents (d).

In a case where the agricultural formulation contains an organic solvent inferior in the miscibility with water, in order that the agricultural formulation is uniformly diluted with water while suppressing foaming, it is preferred to increase the content of the surfactant (b) and/or the silicone compound (c) in some cases.

In the agricultural formulation of the present invention, the weight ratio of the agriculturally active ingredient (a) to the surfactant (b) is usually from 1:5 to 5:1, preferably from 1:3 to 3:1, more preferably from 1:2 to 2:1.

In the agricultural formulation of the present invention, the weight ratio of the agriculturally active ingredient (a) to the silicone compound (c) is usually from 200:1 to 1:1, preferably from 100:1 to 1:1, more preferably from 50:1 to 1:1.

In the agricultural formulation of the present invention, the weight ratio of the surfactant (b) to the organic solvent (d) is usually from1:50 to 1:1, preferably from 1:30 to 1:1, more preferably from 1:15 to 1:1.

In the agricultural formulation of the present invention, the weight ratio of the silicone compound (c) to the organic solvent (d) is usually from 1:1,000 to 1:10, preferably from 1:500 to 1:10, more preferably from 1:300 to 1:10.

The agricultural formulation of the present invention may further contain, as the case requires, other additives such as an antifreezing agent (such as propylene glycol, dipropylene glycol, dipropylene glycol monomethyl ether or polyethylene glycol), a pH adjustor (such as acetic acid, phosphoric acid, citric acid, boric acid, tris-base or sodium hydroxide), an adjuvant (esterified rapeseed oil, methylated soybean oil, polyoxyethylene di methylsiloxane, polyoxyethylene alkyl phenyl ether methylated rapeseed oil or hydroxypropyl heptamethyltrisiloxane), a binder (such as polyvinyl alcohol or polyvinyl pyrrolidone), and a preservative.

The agricultural formulation of the present invention may be produced in accordance with a conventional method for producing an agricultural formulation. Specifically, the agriculturally active ingredient (a), the surfactant (b), the silicone compound (c) and the organic solvent (d), and as the case requires, other additives, may be mixed in an optional order and dissolved to produce the agricultural formulation. Further, in production of the agricultural formulation of the present invention, as the case requires, heating may be conducted at from about 30 to about 80° C. to facilitate dissolution.

Specific examples of the production method are as follows.

A method of dissolving the agriculturally active ingredient (a), the surfactant (b) and the silicone compound (c) in the organic solvent (d) to produce the agricultural formulation;

a method of adding the silicone compound (c) to a composition having the agriculturally active ingredient (a) and the surfactant (b) dissolved in the organic solvent (d) to produce the agricultural formulation;

a method of adding the surfactant (b) to a composition having the agriculturally active ingredient (a) and the silicone compound (c) dissolved in the organic solvent (d) to produce the agricultural formulation;

a method of adding the agriculturally active ingredient (a) and the surfactant (b) to a composition having the silicone compound (c) dissolved in the organic solvent (d) to produce the agricultural formulation; and

a method of dissolving the agriculturally active ingredient (a) to a composition having the surfactant (b) and the silicone compound (c) dissolved in the organic solvent (d) to produce the agricultural formulation.

In actual use of the agricultural formulation, the agricultural formulation of the present invention is 10 to 10,000-fold diluted with water to prepare a spray solution, which is applied in accordance with an application method known in this technical field. When the spray solution is prepared, the agricultural formulation of the present invention is prevented from foaming, however, it is more preferred to conduct stirring in the solution as far as possible so as not to include air bubbles. Further, when the agricultural formulation of the present invention is diluted with water in a predetermined amount of water to prepare a spray solution, commercially available other agricultural formulations, adjuvants (for example, vegetable oil ester type Actirob B, Destiny, phase II, polyoxyethylene alkyl phenyl ether type Persist Ultra, silicone type Dyne-Amic, SYL-TAC, etc.), fertilizers (for example, foliar spray fertilizer, HB-101 (natural plant vitalizer), neem) and the like which are commonly used in this technical field, may be added to prepare a spray solution, and in such an embodiment also, the effect to suppress foaming of the agricultural formulation of the present invention is exerted.

Now, preferred embodiments of the present invention are described below, but the present invention is not limited thereto.
[1] An agricultural formulation comprising an agriculturally active ingredient (a), a surfactant (b), a silicone compound (c) represented by the following formula (I) and an organic solvent (d), wherein (a), (b) and (c) are dissolved in (d):

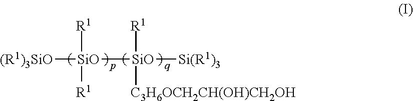

wherein R¹ are each independently a C₁₋₂₀ alkyl group, p is an integer of from 0 to 3, and q is an integer of from 1 to 2.
[2] The agricultural formulation according to [1], which has a form of a clear liquid.
[3] The agricultural formulation according to [1] or [2], which has a transmittance to light at a wavelength of from 590 to 750 nm of at least 94%.
[4] The agricultural formulation according to [1] or [2], which has a transmittance to light at a wavelength of 660 nm of at least 94%.
[5] The agricultural formulation according to any one of [1] to [4], wherein the surfactant (b) is one or more members selected from the group consisting of a non-ionic surfactant and an anionic surfactant.
[6] The agricultural formulation according to any one of [1] to [4], wherein the surfactant (b) is one or more members selected from the group consisting of a polyoxyalkylene surfactant, a block copolymer surfactant, a sulfonate surfactant, a sulfate ester surfactant and a phosphate ester surfactant.
[7] The agricultural formulation according to any one of [1] to [6], wherein the silicone compound (c) represented by the formula (I) is compound represented by the following formula (II):

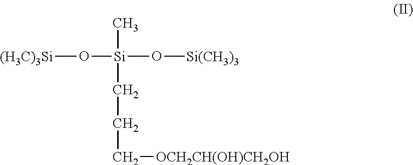

[8] The agricultural formulation according to any one of [1] to [7], wherein the organic solvent (d) is one or more members selected from the group consisting of an amide, a sulfoxide, a ketone, a lactone, a pyrrolidone, an alcohol, an ether and an ester.
[9] The agricultural formulation according to any one of [1] to [7], wherein the organic solvent (d) is one or more members selected from the group consisting of N,N-dimethylacetamide, N,N-dimethylformamide, N-methyl-2-pyrrolidone, N-octyl-2-pyrrolidone, dimethyl sulfoxide, cyclohexanone, γ-butyrolactone, propylene glycol, cyclohexanol, n-hexanol, tetrahydrofurfuryl alcohol, propylene glycol monomethyl ether, dipropylene glycol monomethyl ether, dipropylene glycol dimethyl ether and dimethyl 2-methylglutarate.
[10] The agricultural formulation according to any one of [1] to [9], wherein the content of the organic solvent (d) in the agricultural formulation is from 1 to 99 wt %.
[11] The agricultural formulation according to any one of [1] to [10], wherein the content of the silicone compound (c) in the agricultural formulation is from 0.01 to 10 wt %.
[12] The agricultural formulation according to any one of [1] to [11], which is SL (soluble concentrate), DC (dispersible concentrate) or ME (microemulsion).
[13] The agricultural formulation according to any one of [1] to [12], wherein the agriculturally active ingredient (a) is one or more members selected from the group consisting of herbicides such as pyrazole compounds (preferably e.g. tolpyralate), sulfonylurea compounds (preferably e.g. nicosulfuron, flazasulfuron and flucetosulfuron), aryloxypropionate compounds (preferably e.g. fluazifop-P), and triketone compounds (preferably e.g. lancotrione);

insecticides such as diamide compounds (preferably e.g. cyclaniliprole, chlorantraniliprole, cyantraniliprole and flubendiamide), flonicamid, benzoylurea compounds (preferably e.g. chlorfluazuron), organophosphorus compounds (preferably e.g. fosthiazate, chlorpyrifos, cadusafos and imicyafos, more preferably e.g. fosthiazate), and neonicotinoid compounds (preferably e.g. imidacloprid, acetamiprid and thiamethoxam); and

fungicides such as cyanoimidazole compounds (preferably e.g. cyazofamid), 2,6-nitroaniline compounds (preferably e.g. fluazinam), phenyloxoethyl thiophenamide compounds (preferably e.g. isofetamid), and benzoylpyridine compounds (preferably e.g. pyriofenone).
[14] A method for suppressing foaming of a water-dilution of an agricultural formulation comprising an agriculturally active ingredient (a), a surfactant (b), a silicone compound (c) represented by the following formula (I) and an organic solvent (d), by dissolving the silicone compound (c) in a mixture comprising the active ingredient (a), the surfactant (b) and the organic solvent (d):

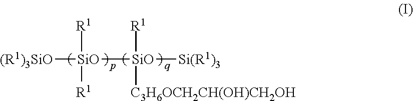

wherein R¹ are each independently a C₁₋₂₀ alkyl group, p is an integer of from 0 to 3, and q is an integer of from 1 to 2.

[15] The method according to [14], wherein the agricultural formulation has a form of a clear liquid.
[16] The method according to [14] or [15], wherein the agricultural formulation has a transmittance to light at a wavelength of from 590 to 750 nm of at least 94%.
[17] The method according to [14] or [15], wherein the agricultural formulation has a transmittance to light at a wavelength of 660 nm of at least 94%.
[18] The method according to any one of [14] to [17], wherein the surfactant (b) is one or more members selected from the group consisting of a nonionic surfactant and an anionic surfactant.
[19] The method according to any one of [14] to [17], wherein the surfactant (b) is one or more members selected from the group consisting of a polyoxyalkylene surfactant, a block copolymer surfactant, a sulfonate surfactant, a sulfate ester surfactant and a phosphate ester surfactant.
[20] The method according to any one of [14] to [19], wherein the silicone compound (c) represented by the formula (I) is compound represented by the following formula (II):

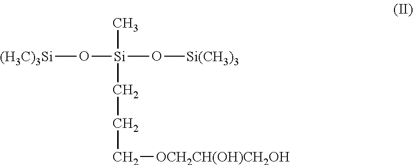

[21] The method according to any one of [14] to [20], wherein the organic solvent (d) is one or more members selected from the group consisting of an amide, a sulfoxide, a ketone, a lactone, a pyrrolidone, an alcohol, an ether and an ester.
[22] The method according to any one of [14] to [20], wherein the organic solvent (d) is one or more members selected from the group consisting of N,N-dimethylacetamide,

N,N-dimethylformamide, N-methyl-2-pyrrolidone, N-octyl-2-pyrrolidone, dimethyl sulfoxide, cyclohexanone, γ-butyrolactone, propylene glycol, cyclohexanol, n-hexanol, tetrahydrofurfuryl alcohol, propylene glycol monomethyl ether, dipropylene glycol monomethyl ether, dipropylene glycol dimethyl ether and dimethyl 2-methylglutarate.
[23] The method according to any one of [14] to [22], wherein the content of the organic solvent (d) in the agricultural formulation is from 1 to 99 wt %.
[24] The method according to any one of [14] to [23], wherein the content of the silicone compound (c) in the agricultural formulation is from 0.01 to 10 wt %.
[25] The method according to any one of [14] to [24], wherein the agricultural formulation is SL (soluble concentrate), DC (dispersible concentrate) or ME (microemulsion).
[26] The method according to any one of [14] to [25], wherein the agriculturally active ingredient (a) is one or more members selected from the group consisting of herbicides such as pyrazole compounds (preferably e.g. tolpyralate), sulfonylurea compounds (preferably e.g. nicosulfuron, flazasulfuron and flucetosulfuron), aryloxypropionate compounds (preferably e.g. fluazifop-P), and triketone compounds (preferably e.g. lancotrione);

insecticides such as diamide compounds (preferably e.g. cyclaniliprole, chlorantraniliprole, cyantraniliprole and flubendiamide), flonicamid, benzoylurea compounds (preferably e.g. chlorfluazuron), organophosphorus compounds (preferably e.g. fosthiazate, chlorpyrifos, cadusafos and imicyafos, more preferably e.g. fosthiazate), and neonicotinoid compounds (preferably e.g. imidacloprid, acetamiprid and thiamethoxam); and

fungicides such as cyanoimidazole compounds (preferably e.g. cyazofamid), 2,6-nitroaniline compounds (preferably e.g. fluazinam), phenyloxoethyl thiophenamide compounds (preferably e.g. isofetamid), and benzoylpyridine compounds (preferably e.g. pyriofenone).
[27] Use of a silicone compound (c) represented by the following formula (I) to suppress foaming of water-dilution of an agricultural formulation comprising an agriculturally active ingredient (a), a surfactant (b), the silicone compound (c) and an organic solvent (d), by dissolving the silicone compound (c) in a mixture comprising the active ingredient (a), the surfactant (b) and the organic solvent (d):

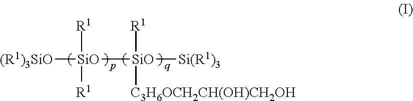

wherein R¹ are each independently a C₁₋₂₀ alkyl group, p is an integer of from 0 to 3, and q is an integer of from 1 to 2.

[28] The use according to [27], wherein the agricultural formulation has a form of a clear liquid.
[29] The use according to [27] or [28], wherein the agricultural formulation has a transmittance to light at a wavelength of from 590 to 750 nm of at least 94%.
[30] The use according to [27] or [28], wherein the agricultural formulation has a transmittance to light at a wavelength of 660 nm of at least 94%.
[31] The use according to any one of [27] to [30], wherein the surfactant (b) is one or more members selected from the group consisting of a nonionic surfactant and an anionic surfactant.
[32] The use according to any one of [27] to [30], wherein the surfactant (b) is one or more members selected from the group consisting of a polyoxyalkylene surfactant, a block copolymer surfactant, a sulfonate surfactant, a sulfate ester surfactant and a phosphate ester surfactant.
[33] The use according to any one of [27] to [31], wherein the silicone compound (c) represented by the formula (I) is compound represented by the following formula (II):

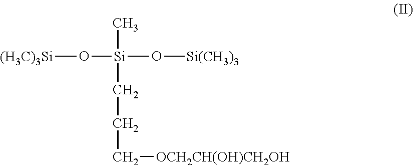

[34] The use according to any one of
[27] to
[33], wherein the organic solvent (d) is one or more members selected from the group consisting of an amide, a sulfoxide, a ketone, a lactone, a pyrrolidone, an alcohol, an ether and an ester.
[35] The use according to any one of [27] to [33], wherein the organic solvent (d) is one or more members selected from the group consisting of N,N-dimethylacetamide, N,N-dimethylformamide, N-methyl-2-pyrrolidone, N-octyl-2-pyrrolidone, dimethyl sulfoxide, cyclohexanone, γ-butyrolactone, propylene glycol, cyclohexanol, n-hexanol, tetrahydrofurfuryl alcohol, propylene glycol monomethyl ether, dipropylene glycol monomethyl ether, dipropylene glycol dimethyl ether and dimethyl 2-methylglutarate.
[36] The use according to any one of [27] to [35], wherein the content of the organic solvent (d) in the agricultural formulation is from 1 to 99 wt %.
[37] The use according to any one of [27] to [36], wherein the content of the silicone compound (c) in the agricultural formulation is from 0.01 to 10 wt %.
[38] The use according to any one of [27] to [37], which is SL (soluble concentrate), DC (dispersible concentrate) or ME (microemulsion).
[39] The use according to any one of [27] to [38], wherein the agriculturally active ingredient (a) is one or more members selected from the group consisting of herbicides such as pyrazole compounds (preferably e.g. tolpyralate), sulfonylurea compounds (preferably e.g. nicosulfuron, flazasulfuron and flucetosulfuron), aryloxypropionate compounds (preferably e.g. fluazifop-P), and triketone compounds (preferably e.g. lancotrione);

insecticides such as diamide compounds (preferably e.g. cyclaniliprole, chlorantraniliprole, cyantraniliprole and flubendiamide), flonicamid, benzoylurea compounds (preferably e.g. chlorfluazuron), organophosphorus compounds (preferably e.g. fosthiazate, chlorpyrifos, cadusafos and imicyafos, more preferably e.g. fosthiazate), and neonicotinoid compounds (preferably e.g. imidacloprid, acetamiprid and thiamethoxam); and

fungicides such as cyanoimidazole compounds (preferably e.g. cyazofamid), 2,6-nitroaniline compounds (preferably e.g. fluazinam), phenyloxoethyl thiophenamide compounds (preferably e.g. isofetamid), and benzoylpyridine compounds (preferably e.g. pyriofenone).
[40] A combination of a surfactant (b), a silicone compound (c) represented by the following formula (I) and an organic solvent (d) in production of an agricultural formulation having an agriculturally active ingredient (a) dissolved:

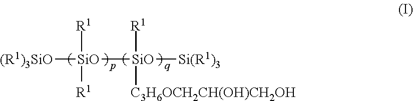

wherein R¹ are each independently a C₁₋₂₀ alkyl group, p is an integer of from 0 to 3, and q is an integer of from 1 to 2.

[41] The combination according to [40], wherein the agricultural formulation has a form of a clear liquid.
[42] The combination according to [40] or [41], wherein the agricultural formulation has a transmittance to light at a wavelength of from 590 to 750 nm of at least 94%.
[43] The combination according to [40] or [41], wherein the agricultural formulation has a transmittance to light at a wavelength of 660 nm of at least 94%.
[44] The combination according to any one of [40] to [43], wherein the surfactant (b) is one or more members selected from the group consisting of a nonionic surfactant and an anionic surfactant.
[45] The combination according to any one of [40] to [43], wherein the surfactant (b) is one or more members selected from the group consisting of a polyoxyalkylene surfactant, a block copolymer surfactant, a sulfonate surfactant, a sulfate ester surfactant and a phosphate ester surfactant.
[46] The combination according to any one of [40] to [45], wherein the silicone compound (c) represented by the formula (I) is compound represented by the following formula (II):

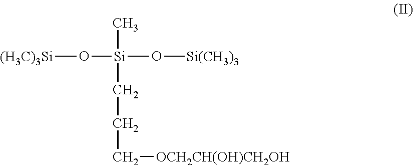

[47] The combination according to any one of [40] to [46], wherein the organic solvent (d) is one or more members selected from the group consisting of an amide, a sulfoxide, a ketone, a lactone, a pyrrolidone, an alcohol, an ether and an ester.
[48] The combination according to any one of [40] to [47], wherein the organic solvent (d) is one or more members selected from the group consisting of N,N-dimethylacetamide, N,N-dimethylformamide, N-methyl-2-pyrrolidone, N-octyl-2-pyrrolidone, dimethyl sulfoxide, cyclohexanone, γ-butyrolactone, propylene glycol, cyclohexanol, n-hexanol, tetrahydrofurfuryl alcohol, propylene glycol monomethyl ether, dipropylene glycol monomethyl ether, dipropylene glycol dimethyl ether and dimethyl 2-methylglutarate.
[49] The combination according to any one of [40] to [48], wherein the content of the organic solvent (d) in the agricultural formulation is from 1 to 99 wt %.
[50] The combination according to any one of [40] to [49], wherein the content of the silicone compound (c) represented by the formula (I) in the agricultural formulation is from 0.01 to 10 wt %.
[51] The combination according to any one of [40] to [50], which is SL (soluble concentrate), DC (dispersible concentrate) or ME (microemulsion).
[52] Use of a combination of a surfactant (b), a silicone compound (c) represented by the following formula (I) and an organic solvent (d) in production of an agricultural formulation having an agriculturally active ingredient (a) dissolved:

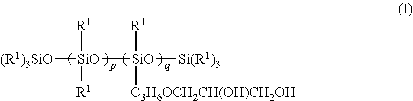

wherein R¹ are each independently a C₁₋₂₀ alkyl group, p is an integer of from 0 to 3, and q is an integer of from 1 to 2.
[53] The use of a combination according to [52], wherein the agricultural formulation has a form of a clear liquid.
[54] The use of a combination according to [52] or [53], wherein the agricultural formulation has a transmittance to light at a wavelength of from 590 to 750 nm of at least 94%.
[55] The use of a combination according to [52] or [53], wherein the agricultural formulation has a transmittance to light at a wavelength of 660 nm of at least 94%.
[56] The use of a combination according to any one of [52] to [55], wherein the surfactant (b) is one or more members selected from the group consisting of a nonionic surfactant and an anionic surfactant.
[57] The use of a combination according to any one of [52] to [55], wherein the surfactant (b) is one or more members selected from the group consisting of a polyoxyalkylene surfactant, a block copolymer surfactant, a sulfonate surfactant, a sulfate ester surfactant and a phosphate ester surfactant.
[58] The use of a combination according to any one of [52] to [57], wherein the silicone compound (c) represented by the formula (I) is compound represented by the following formula (II):

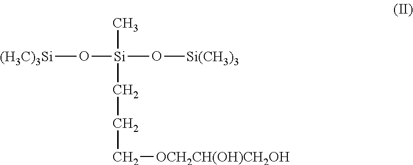

[59] The use of a combination according to any one of [52] to [58], wherein the organic solvent (d) is one or more members selected from the group consisting of an amide, a sulfoxide, a ketone, a lactone, a pyrrolidone, an alcohol, an ether and an ester.
[60] The use of a combination according to any one of [52] to [58], wherein the organic solvent (d) is one or more members selected from the group consisting of N,N-dimethylacetamide, N,N-dimethylformamide, N-methyl-2-pyrrolidone, N-octyl-2-pyrrolidone, dimethyl sulfoxide, cyclohexanone, γ-butyrolactone, propylene glycol, cyclohexanol, n-hexanol, tetrahydrofurfuryl alcohol, propylene glycol monomethyl ether, dipropylene glycol monomethyl ether, dipropylene glycol dimethyl ether and dimethyl 2-methylglutarate.
[61] The use of a combination according to any one of [52] to [60], wherein the content of the organic solvent (d) in the agricultural formulation is from 1 to 99 wt %.
[62] The use of a combination according to any one of [52] to [61], wherein the content of the silicone compound (c) in the agricultural formulation is from 0.01 to 10 wt %.
[63] The use of a combination according to any one of [52] to [62], which is SL (soluble concentrate), DC (dispersible concentrate) or ME (microemulsion).

### EXAMPLES

Now, the present invention will be described in further detail with reference to specific Examples, however, the present invention is not limited to the following Examples.

### Production of Agricultural Formulation

Components in amounts as identified in the following Tables 1 to 7 were mixed to produce agricultural formulations. The numerical values represent part(s) by weight.

Surfactants (b) used are as follows.

TABLE D

| | Component |
|---|---|
| (b)-1 | Polyoxyethylene styryl phenyl ether |
| (b)-2 | Polyoxyethylene styryl phenyl ether sulfate |
| | ammonium salt |
| (b)-3 | Polyoxyethylene polyoxypropylene |
| | block copolymer |
| (b)-4 | Sodium lauryl sulfate |
| (b)-5 | Calcium alkylbenzenesulfonate |
| (b)-6 | Polyoxyethylene styryl phenyl ether |
| | phosphate ester |
| (b)-7 | Polyoxyethylene tallow amine |
| (b)-8 | Polyoxyethylene castor oil |
| (b)-9 | Polyoxyethylene dimethylsiloxane |
| (b)-10 | N-Coconut oil fatty acid acyl-L-glutamic |
| | acid triethanolamine |

### Test Methods

(1) Observation of Appearance of Agricultural Formulation

The appearance of the produced agricultural formulation was visually observed and evaluated based on the following criteria.

◯: No turbidity observed.

x : Turbidity observed.
(2) Measurement of Transmittance

The absorbance of the produced agricultural formulation was measured with respect to light at a wavelength of 660 nm, using as a blank an agricultural formulation containing the agriculturally active ingredient (a), the surfactant (b) and the organic solvent (d), by an ultraviolet visible spectrometer UV-2550 (manufactured by Shimadzu Corporation) (room temperature, optical path length: 100 mm, quartz cell volume: 3.7 mL), whereby the transmittance was obtained.
(3) Evaluation of Foaming Properties

200 mL of water was put into a 250 mL measuring cylinder with a stopper at 25±5° C., and 0.2 g of the agricultural formulation was added. The measuring cylinder stopped was inverted 30 times in about one minute and then left at rest for 1 minute, whereupon the volume of foam was measured. In Example 1, after the measuring cylinder was left at rest for one minute, filtration was conducted, and the volume of foam after filtration was also measured.

### Example 1: Evaluation of Silicone Compound (c)

An agricultural formulation was produced using (a) to (d) as identified in the following Table 1, and observation of appearance, measurement of the transmittance and evaluation of foaming properties were conducted. The results are shown in Table 1. In Table 1, No.1-1 corresponds to an Example of the present invention, and No. 1-2 to 1-9 correspond to Comparative Examples. In Example 1, measurement of the transmittance was conducted before and after filtration of the agricultural formulation, and evaluation of foaming properties was conducted according to above mentioned measurement before and after filtration.

TABLE 1

| | | No. | | | | | | | | |
|---|---|---|---|---|---|---|---|---|---|---|
| Component | | 1-1 | 1-2 | 1-3 | 1-4 | 1-5 | 1-6 | 1-7 | 1-8 | 1-9 |
| (a) | Cyclaniliprole | 9.9 | 9.9 | 9.9 | 9.9 | 9.9 | 9.9 | 9.9 | 9.9 | 9.9 |
| (b) | (b)-1 | 11.6 | 11.6 | 11.6 | 11.6 | 11.6 | 11.6 | 11.6 | 11.6 | 11.6 |
| (b) | (b)-5 | 2.9 | 2.9 | 2.9 | 2.9 | 2.9 | 2.9 | 2.9 | 2.9 | 2.9 |
| (c) | Compound of the | 0.1 | — | — | — | — | — | — | — | — |
| | formula (II) | | | | | | | | | |
| (c′) | THF-450-350 | — | 0.1 | — | — | — | — | — | — | — |
| (c′) | KS-530 | — | — | 0.1 | — | — | — | — | — | — |
| (c′) | SAG47 | — | — | — | 0.1 | — | — | — | — | — |
| (c′) | TSA750 | — | — | — | — | 0.1 | — | — | — | — |
| (c′) | SAG1538 | — | — | — | — | — | 0.1 | — | — | — |
| (c′) | FOAMLEX 770 | — | — | — | — | — | — | 0.1 | — | — |
| (c′) | YSA6403 | — | — | — | — | — | — | — | 0.1 | — |
| (c′) | Nil | — | — | — | — | — | — | — | — | — |
| (d) | Dimethyl sulfoxide | 28.9 | 28.9 | 28.9 | 28.9 | 28.9 | 28.9 | 28.9 | 28.9 | 28.9 |
| (d) | Cyclohexanone | 46.6 | 46.6 | 46.6 | 46.6 | 46.6 | 46.6 | 46.6 | 46.6 | 46.6 |
| Appearance | | ◯ | X | X | X | X | X | ◯ | ◯ | ◯ |
| Transmittance (%) | Before filtration | 100 | 45 | 55 | 45 | 46 | 38 | 99 | 100 | 100 |
| | After filtration | 100 | 100 | 100 | 100 | 100 | 100 | 99 | 100 | 100 |
| Amount of | Before filtration | 2 | 40 | 40 | 26 | 24 | 2 | 52 | 50 | 48 |
| foam (mL) | After filtration | 2 | 50 | 52 | 52 | 50 | 48 | 50 | 50 | 48 |

As shown in Table 1, it was found that the agricultural formulation of the present invention was clear (that is, appearance: 0, transmittance: at least 94%), and by containing the silicone compound represented by the formula (II), foaming when the agricultural formulation was diluted with water was remarkably suppressed. On the other hand, with various defoaming agents (c′) used in this technical field, it was not possible to satisfy both impartment of clarity and suppression of foaming.

### Example 2: Evaluation 1 of Surfactant (b)

In order to confirm application range of the present invention, agricultural formulations were produced using dimethyl sulfoxide as the organic solvent (d) and various surfactants (b), and observation of appearance and evaluation of foaming properties were conducted. The results are shown in Tables 2-1 and 2-2. Table 2-1 shows Examples of the present invention, and Table 2-2 shows Comparative Examples in which no silicone compound (c) was contained.

TABLE 2-1

| | | No. | | | | | | | | | |
|---|---|---|---|---|---|---|---|---|---|---|---|
| Component | | 2-1 | 2-2 | 2-3 | 2-4 | 2-5 | 2-6 | 2-7 | 2-8 | 2-9 | 2-10 |
| (a) | Nil | — | — | — | — | — | — | — | — | — | — |
| (b) | (b)-1 | 1 | — | — | — | — | — | — | — | — | — |
| (b) | (b)-2 | — | 1 | — | — | — | — | — | — | — | — |
| (b) | (b)-3 | — | — | 1 | — | — | — | — | — | — | — |
| (b) | (b)-4 | — | — | — | 1 | — | — | — | — | — | — |
| (b) | (b)-5 | — | — | — | — | 1 | — | — | — | — | — |
| (b) | (b)-7 | — | — | — | — | — | 1 | — | — | — | — |
| (b) | (b)-8 | — | — | — | — | — | — | 1 | — | — | — |
| (b) | (b)-9 | — | — | — | — | — | — | — | 1 | — | — |
| (b) | (b)-10 | — | — | — | — | — | — | — | — | 20 | — |
| (b) | (b)-6 | — | — | — | — | — | — | — | — | — | 1 |
| (c) | Compound of | 0.5 | 0.5 | 0.5 | 0.5 | 0.5 | 0.5 | 0.5 | 0.5 | 0.5 | 0.5 |
| | the formula (II) | | | | | | | | | | |
| (d) | Dimethyl | 99 | 99 | 99 | 99 | 99 | 99 | 99 | 99 | 79 | 99 |
| | sulfoxide | | | | | | | | | | |

| | | | | | | | | | | |
|---|---|---|---|---|---|---|---|---|---|---|
| Appearance | ◯ | ◯ | ◯ | ◯ | ◯ | ◯ | ◯ | ◯ | ◯ | ◯ |
| Amount of foam (mL) | 0 | 12 | 4 | 12 | 0 | 6 | 8 | 6 | 22 | 20 |

TABLE 2-2

| | | No. | | | | | | | | | |
|---|---|---|---|---|---|---|---|---|---|---|---|
| Component | | 2-11 | 2-12 | 2-13 | 2-14 | 2-15 | 2-16 | 2-17 | 2-18 | 2-19 | 2-20 |
| (a) | Nil | — | — | — | — | — | — | — | — | — | — |
| (b) | (b)-1 | 1 | — | — | — | — | — | — | — | — | — |
| (b) | (b)-2 | — | 1 | — | — | — | — | — | — | — | — |
| (b) | (b)-3 | — | — | 1 | — | — | — | — | — | — | — |
| (b) | (b)-4 | — | — | — | 1 | — | — | — | — | — | — |
| (b) | (b)-5 | — | — | — | — | 1 | — | — | — | — | — |
| (b) | (b)-7 | — | — | — | — | — | 1 | — | — | — | — |
| (b) | (b)-8 | — | — | — | — | — | — | 1 | — | — | — |
| (b) | (b)-9 | — | — | — | — | — | — | — | 1 | — | — |
| (b) | (b)-10 | — | — | — | — | — | — | — | — | 20 | |
| (b) | (b)-6 | — | — | — | — | — | — | — | — | — | 1 |
| (c) | Compound of | — | — | — | — | — | — | — | — | — | — |
| | the formula (II) | | | | | | | | | | |
| (d) | Dimethyl | 99 | 99 | 99 | 99 | 99 | 99 | 99 | 99 | 79 | 99 |
| | sulfoxide | | | | | | | | | | |

| | | | | | | | | | | |
|---|---|---|---|---|---|---|---|---|---|---|
| Appearance | ◯ | ◯ | ◯ | ◯ | ◯ | ◯ | ◯ | ◯ | ◯ | ◯ |
| Amount of foam (mL) | 42 | 56 | 40 | 48 | 40 | 50 | 30 | 26 | 56 | 52 |

It was confirmed that clear agricultural formulations were obtained even with various surfactants, and an effect to suppress foaming by the silicone compound (c) was confirmed.

### Example 3: Evaluation 2 of Surfactant (b)

To evaluate whether or not the effects shown in Example 2 were obtained in the presence of the agriculturally active ingredient (a), agricultural formulations were produced using dimethyl sulfoxide as the organic solvent (d) and various surfactants (b), and observation of appearance and evaluation of foaming properties were conducted. The results are shown in Tables 3-1 and 3-2. Table 3-1 shows Examples of the present invention, and Table 3-2 shows Comparative Examples in which no silicone compound (c) was contained. As the agriculturally active ingredient (a), cyclaniliprole (water solubility: 0.1 ppm) and flonicamid (water solubility: 5,200 ppm) differing in the solubility were used.

TABLE 3-1

| | | No. | | | | | | | |
|---|---|---|---|---|---|---|---|---|---|
| Component | | 3-1 | 3-2 | 3-3 | 3-4 | 3-5 | 3-6 | 3-7 | 3-8 |
| (a) | Cyclaniliprole | 1 | 1 | 1 | 1 | — | — | — | — |
| (a) | Flonicamid | — | — | — | — | 1 | 1 | 1 | 1 |
| (b) | (b)-2 | 2 | — | — | — | 2 | — | — | — |
| (b) | (b)-3 | — | 2 | — | — | — | 2 | — | — |
| (b) | (b)-4 | — | — | 2 | — | — | — | 2 | — |
| (b) | (b)-6 | — | — | — | 2 | — | — | — | 2 |
| (c) | Compound of | 0.5 | 0.5 | 0.5 | 0.5 | 0.5 | 0.5 | 0.5 | 0.5 |
| | the formula (II) | | | | | | | | |
| (d) | Dimethyl | 97 | 97 | 97 | 97 | 97 | 97 | 97 | 97 |
| | sulfoxide | | | | | | | | |

| | | | | | | | | |
|---|---|---|---|---|---|---|---|---|
| Appearance | ◯ | ◯ | ◯ | ◯ | ◯ | ◯ | ◯ | ◯ |
| Amount of foam (mL) | 0 | 6 | 0 | 4 | 14 | 4 | 14 | 20 |

TABLE 3-2

| | | No. | | | | | | | |
|---|---|---|---|---|---|---|---|---|---|
| Component | | 3-9 | 3-10 | 3-11 | 3-12 | 3-13 | 3-14 | 3-15 | 3-16 |
| (a) | Cyclaniliprole | 1 | 1 | 1 | 1 | — | — | — | — |
| (a) | Flonicamid | — | — | — | — | 1 | 1 | 1 | 1 |
| (b) | (b)-2 | 2 | — | — | — | 2 | — | — | — |
| (b) | (b)-3 | — | 2 | — | — | — | 2 | — | — |
| (b) | (b)-4 | — | — | 2 | — | — | — | 2 | — |
| (b) | (b)-6 | — | — | — | 2 | — | — | — | 2 |
| (c) | Compound of | — | — | — | — | — | — | — | — |
| | the formula (II) | | | | | | | | |
| (d) | Dimethyl | 97 | 97 | 97 | 97 | 97 | 97 | 97 | 97 |
| | sulfoxide | | | | | | | | |

| | | | | | | | | |
|---|---|---|---|---|---|---|---|---|
| Appearance | ◯ | ◯ | ◯ | ◯ | ◯ | ◯ | ◯ | ◯ |
| Amount of foam (mL) | 36 | 26 | 30 | 30 | 60 | 50 | 55 | 50 |

Even in the presence of the agriculturally active ingredient (a), clear agricultural formulations were obtained using various surfactants, and the effects to suppress foaming by the silicone compound (c) were confirmed.

### Example 4: Evaluation 1 of Organic Solvent (d)

Agricultural formulations were produced using SORPOL T-20 as the surfactant (b) and various organic solvents (d), and observation of appearance and evaluation of foaming properties were conducted. The results are shown in Tables 4-1 and 4-2. Table 4-1 shows Examples of the present invention, and Table 4-2 shows Comparative Examples in which no silicone compound (c) was contained.

TABLE 4-1

| | | No. | | | | | | |
|---|---|---|---|---|---|---|---|---|
| Component | | 4-1 | 4-2 | 4-3 | 4-4 | 4-5 | 4-6 | 4-7 |
| (a) | Nil | — | — | — | — | — | — | — |
| (b) | (b)-1 | 1 | 1 | 1 | 1 | 1 | 1 | 1 |
| (c) | Compound of | 0.5 | 0.5 | 0.5 | 0.5 | 0.5 | 0.5 | 0.5 |
| | the formula (II) | | | | | | | |
| (d) | N-Methylpyrrolidone | 99 | — | — | — | — | — | — |
| (d) | Propylene glycol | — | 99 | — | — | — | — | — |
| (d) | Rhodiasolv Polaclean | — | — | 99 | — | — | — | — |
| (d) | Rhodiasolv IRIS | — | — | — | 99 | — | — | — |
| (d) | Cyclohexanone | — | — | — | — | 99 | — | — |
| (d) | Cyclohexanol | — | — | — | — | — | 99 | — |
| (d) | n-Hexanol | — | — | — | — | — | — | 99 |

| | | | | | | | |
|---|---|---|---|---|---|---|---|
| Appearance | ◯ | ◯ | ◯ | ◯ | ◯ | ◯ | ◯ |
| Amount of foam (mL) | 0 | 0 | 0 | 0 | 0 | 0 | 2 |

TABLE 4-2

| | | No. | | | | | | |
|---|---|---|---|---|---|---|---|---|
| Component | | 4-8 | 4-9 | 4-10 | 4-11 | 4-12 | 4-13 | 4-14 |
| (a) | Nil | — | — | — | — | — | — | — |
| (b) | (b)-1 | 1 | 1 | 1 | 1 | 1 | 1 | 1 |
| (c) | Compound of | — | — | — | — | — | — | — |
| | the formula (II) | | | | | | | |
| (d) | N-Methylpyrrolidone | 99 | — | — | — | — | — | — |
| (d) | Propylene glycol | — | 99 | — | — | — | — | — |
| (d) | Rhodiasolv Polaclean | — | — | 99 | — | — | — | — |
| (d) | Rhodiasolv IRIS | — | — | — | 99 | — | — | — |
| (d) | Cyclohexanone | — | — | — | — | 99 | — | — |
| (d) | Cyclohexanol | — | — | — | — | — | 99 | — |
| (d) | n-Hexanol | — | — | — | — | — | — | 99 |

| | | | | | | | |
|---|---|---|---|---|---|---|---|
| Appearance | ◯ | ◯ | ◯ | ◯ | ◯ | ◯ | ◯ |
| Amount of foam (mL) | 40 | 40 | 50 | 50 | 39 | 40 | 36 |

Clear agricultural formulations were obtained with other organic solvent in the same manner as dimethyl sulfoxide used in Examples 1 and 2, and the effects to suppress foaming by the silicone compound (c) were confirmed.

### Example 5: Evaluation 2 of Organic Solvent (d)

To evaluate whether or not the effects shown in Example 4 were obtained in the presence of the agriculturally active ingredient (a), agricultural formulations were produced using SORPOL T-20 as the surfactant (b) and various organic solvents (d), and observation of appearance and evaluation of foaming properties were conducted. The results are shown in Tables 5-1 to 5-4. Tables 5-1 and 5-3 show Examples of the present invention, and Tables 5-2 and 5-4 show Comparative Examples in which no silicone compound (c) was contained. As the agriculturally active ingredient (a), cyclaniliprole and flonicamid differing in the solubility were used.

TABLE 5-1

| | | No. | | | | | |
|---|---|---|---|---|---|---|---|
| Component | | 5-1 | 5-2 | 5-3 | 5-4 | 5-5 | 5-6 |
| (a) | Cyclaniliprole | 0.8 | 0.8 | 0.8 | 0.8 | 0.8 | 0.8 |
| (b) | (b)-1 | 1.6 | 1.6 | 1.6 | 1.6 | 1.6 | 1.6 |
| (c) | Compound of | 0.5 | 0.5 | 0.5 | 0.5 | 0.5 | 0.5 |
| | the formula (II) | | | | | | |
| (d) | Dimethyl sulfoxide | 97 | 77.6 | 77.6 | 77.6 | 77.6 | 77.6 |
| (d) | Propanol | — | 20 | — | — | — | — |
| (d) | Butanol | — | — | 20 | — | — | — |
| (d) | Benzyl alcohol | — | — | — | 20 | — | — |
| (d) | n-Hexanol | — | — | — | — | 20 | — |
| (d) | Propylene glycol | — | — | — | — | — | 20 |

| | | | | | | |
|---|---|---|---|---|---|---|
| Appearance | ◯ | ◯ | ◯ | ◯ | ◯ | ◯ |
| Amount of foam (mL) | 0 | 0 | 0 | 0 | 0 | 0 |

TABLE 5-2

| | | No. | | | | | |
|---|---|---|---|---|---|---|---|
| Component | | 5-7 | 5-8 | 5-9 | 5-10 | 5-11 | 5-12 |
| (a) | Cyclaniliprole | 0.8 | 0.8 | 0.8 | 0.8 | 0.8 | 0.8 |
| (b) | (b)-1 | 1.6 | 1.6 | 1.6 | 1.6 | 1.6 | 1.6 |
| (c) | Compound of | — | — | — | — | — | — |
| | the formula (II) | | | | | | |
| (d) | Dimethyl sulfoxide | 97 | 77.6 | 77.6 | 77.6 | 77.6 | 77.6 |
| (d) | Propanol | — | 20 | — | — | — | — |
| (d) | Butanol | — | — | 20 | — | — | — |
| (d) | Benzyl alcohol | — | — | — | 20 | — | — |
| (d) | n-Hexanol | — | — | — | — | 20 | — |
| (d) | Propylene glycol | — | — | — | — | — | 20 |

| | | | | | | |
|---|---|---|---|---|---|---|
| Appearance | ◯ | ◯ | ◯ | ◯ | ◯ | ◯ |
| Amount of foam (mL) | 22 | 24 | 26 | 20 | 20 | 22 |

TABLE 5-3

| | | No. | | | | | |
|---|---|---|---|---|---|---|---|
| Component | | 5-13 | 5-14 | 5-15 | 5-16 | 5-17 | 5-18 |
| (a) | Flonicamid | 0.8 | 0.8 | 0.8 | 0.8 | 0.8 | 0.8 |
| (b) | (b)-1 | 1.6 | 1.6 | 1.6 | 1.6 | 1.6 | 1.6 |
| (c) | Compound of | 0.5 | 0.5 | 0.5 | 0.5 | 0.5 | 0.5 |
| | the formula (II) | | | | | | |
| (d) | Dimethyl sulfoxide | 97 | 77.6 | 77.6 | 77.6 | 77.6 | 77.6 |
| (d) | Propanol | — | 20 | — | — | — | — |
| (d) | Butanol | — | — | 20 | — | — | — |
| (d) | Benzyl alcohol | — | — | — | 20 | — | — |
| (d) | n-Hexanol | — | — | — | — | 20 | — |
| (d) | Propylene glycol | — | — | — | — | — | 20 |

| | | | | | | |
|---|---|---|---|---|---|---|
| Appearance | ◯ | ◯ | ◯ | ◯ | ◯ | ◯ |
| Amount of foam (mL) | 0 | 0 | 0 | 0 | 0 | 0 |

TABLE 5-4

| | | No. | | | | | |
|---|---|---|---|---|---|---|---|
| Component | | 5-19 | 5-20 | 5-21 | 5-22 | 5-23 | 5-24 |
| (a) | Flonicamid | 0.8 | 0.8 | 0.8 | 0.8 | 0.8 | 0.8 |
| (b) | (b)-1 | 1.6 | 1.6 | 1.6 | 1.6 | 1.6 | 1.6 |
| (c) | Compound of | — | — | — | — | — | — |
| | the formula (II) | | | | | | |
| (d) | Dimethyl sulfoxide | 97 | 77.6 | 77.6 | 77.6 | 77.6 | 77.6 |
| (d) | Propanol | — | 20 | — | — | — | — |
| (d) | Butanol | — | — | 20 | — | — | — |
| (d) | Benzyl alcohol | — | — | — | 20 | — | — |
| (d) | n-Hexanol | — | — | — | — | 20 | — |
| (d) | Propylene glycol | — | — | — | — | — | 20 |

| | | | | | | |
|---|---|---|---|---|---|---|
| Appearance | ◯ | ◯ | ◯ | ◯ | ◯ | ◯ |
| Amount of foam (mL) | 36 | 38 | 42 | 46 | 40 | 42 |

Even in the presence of the agriculturally active ingredient (a), clear agricultural formulations were obtained using various organic solvents, and the effects to suppress foaming by the silicone compound (c) were confirmed.

As shown in Examples 2 to 5, it was found that by combination of the surfactant (b), the silicone compound (c) and the organic solvent (d) of the present invention, clear agricultural formulations containing various agriculturally active ingredients (a), of which foaming when diluted with water is suppressed, can be produced.

### FORMULATION EXAMPLES

Now, Formulation Examples are shown as examples of the agricultural formulations of the present invention.

TABLE 6

| | | No. | | | | | | |
|---|---|---|---|---|---|---|---|---|
| Component | | 6-1 | 6-2 | 6-3 | 6-4 | 6-5 | 6-6 | 6-7 |
| (a) | Cyclaniliprole | 10 | 10 | 10 | 5 | — | — | — |
| (a) | Flonicamid | — | — | — | 10 | — | 20 | — |
| (a) | Tolpyralate | — | — | — | — | 3 | — | — |
| (a) | Chlorfluazuron | — | — | — | — | — | 5 | — |
| (a) | Lancotrione | — | — | — | — | — | — | 10 |
| (b) | (b)-1 | 20 | — | — | 20 | 10 | — | — |
| (b) | (b)-2 | — | 20 | — | — | — | — | — |
| (b) | (b)-3 | — | — | 20 | — | — | — | — |
| (b) | (b)-6 | — | — | — | — | — | — | 2 |
| (b) | Acrylic graft | — | — | — | — | — | 15 | — |
| | copolymer | | | | | | | |
| (c) | Compound of | 0.5 | 0.5 | 0.5 | 0.5 | 1.0 | 0.5 | 0.5 |
| | the formula (II) | | | | | | | |
| (d) | N-Methyl- | 70 | — | — | — | — | 60 | — |
| | 2-pyrrolidone | | | | | | | |
| (d) | Dimethylacetamide | — | 70 | — | — | — | — | — |
| (d) | Dimethyl sulfoxide | — | — | 69.5 | 64.5 | — | — | — |
| (d) | 2-Phenoxyethanol | — | — | — | — | 43 | — | — |
| (d) | Propylene glycol | — | — | — | — | 35 | — | — |
| (d) | Water | — | — | — | — | — | — | 60 |
| Other | Acetic acid | | | 0.5 | | | | |
| Other | Phosphoric acid | | | | 0.5 | | | |

### USE EXAMPLES

In this technical field, when an agricultural formulation is diluted with water, it may be diluted with water together with other agricultural formulation, an adjuvant, a fertilizer or the like to prepare a spray solution (tank mix) in some cases. It was confirmed whether the effect to suppress foaming of the present invention is maintained and there is no problem in preparation of a spray solution even in such use embodiment.

Specifically, an agricultural formulation containing cyclaniliprole (1.0 part by weight), (b)-1 (2.0 parts by weight), compound of the formula (II) (0.5 part by weight) and dimethyl sulfoxide (96.5 parts by weight) was prepared as the agricultural formulation of the present invention, and when the agricultural formulation was 500-fold diluted with water, it was mixed with various adjuvants and fertilizers (Actirob B, Destiny, Dyne-Amic, Persist Ultra, phase II, SYL-TAC, Version, TIPO, neem oil, Tomato Genki Ekihi, Sumitomo liquid fertilizer 2, tradenames) to prepare spray solutions. As a result, spray solutions could be prepared without any problem in all cases.

The entire disclosure of Japanese Patent Application No. 2019-143474 filed on Aug. 5, 2019 including specification, claims and abstract is incorporated herein by reference in its entirety.

1. An agricultural formulation comprising an agriculturally active ingredient (a), a surfactant (b), a silicone compound (c) represented by the following formula (I) and an organic solvent (d), wherein (a), (b) and (c) are dissolved in (d): 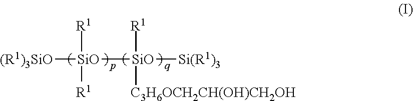
wherein R¹ are each independently a C₁₋₂₀ alkyl group, p is an integer of from 0 to 3, and q is an integer of from 1 to 2.

2. The agricultural formulation according to claim 1, which has a transmittance to light at a wavelength of 660 nm of at least 94%.

3. The agricultural formulation according to claim 1, wherein the surfactant (b) is one or more members selected from the group consisting of a non-ionic surfactant and an anionic surfactant.

4. The agricultural formulation according to claim 1, wherein the surfactant (b) is one or more members selected from the group consisting of a polyoxyalkylene surfactant, a block copolymer surfactant, a sulfonate surfactant, a sulfate ester surfactant and a phosphate ester surfactant.

5. The agricultural formulation according to claim 1, wherein the silicone compound (c) represented by the formula (I) is compound represented by the following formula (II):

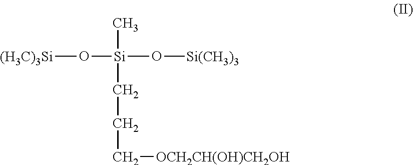

6. The agricultural formulation according to claim 1, wherein the organic solvent (d) is one or more members selected from the group consisting of an amide, a sulfoxide, a ketone, a lactone, a pyrrolidone, an alcohol, an ether and an ester.

7. The agricultural formulation according to claim 1, wherein the organic solvent (d) is one or more members selected from the group consisting of N,N-dimethylacetamide, N,N-dimethylformamide, N-methyl-2-pyrrolidone, N-octyl-2-pyrrolidone, dimethyl sulfoxide, cyclohexanone, γ-butyrolactone, propylene glycol, cyclohexanol, n-hexanol, tetrahydrofurfuryl alcohol, propylene glycol monomethyl ether, dipropylene glycol monomethyl ether, dipropylene glycol dimethyl ether and dimethyl 2-methylglutarate.

8. The agricultural formulation according to claim 1, which is SL (soluble concentrate), DC (dispersible concentrate) or ME (microemulsion).

9. A method for suppressing foaming of a water-dilution of an agricultural formulation comprising an agriculturally active ingredient (a), a surfactant (b), a silicone compound (c) represented by the following formula (I) and an organic solvent (d), by dissolving the silicone compound (c) in a mixture comprising the active ingredient (a), the surfactant (b) and the organic solvent (d): 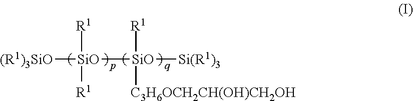
wherein R¹ are each independently a C₁₋₂₀ alkyl group, p is an integer of from 0 to 3, and q is an integer of from 1 to 2.

10. Use of a silicone compound (c) represented by the following formula (I) to suppress foaming of a water-dilution of an agricultural formulation comprising an agriculturally active ingredient (a), a surfactant (b), the silicone compound (c) and an organic solvent (d), by dissolving the silicone compound (c) in a mixture comprising the active ingredient (a), the surfactant (b) and the organic solvent (d): 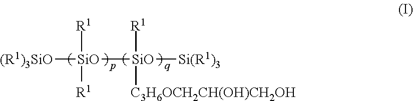
wherein R¹ are each independently a C₁₋₂₀ alkyl group, p is an integer of from 0 to 3, and q is an integer of from 1 to 2.

11. A combination of a surfactant (b), a silicone compound (c) represented by the following formula (I) and an organic solvent (d) in production of an agricultural formulation having an agriculturally active ingredient (a) dissolved: 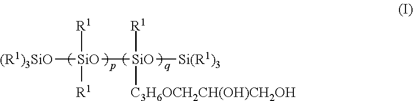
wherein R¹ are each independently a C₁₋₂₀ alkyl group, p is an integer of from 0 to 3, and q is an integer of from 1 to 2.

12. Use of a combination of a surfactant (b), a silicone compound (c) represented by the following formula (I) and an organic solvent (d) in production of an agricultural formulation having an agriculturally active ingredient (a) dissolved: 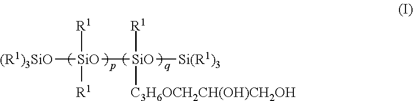
wherein R¹ are each independently a C₁₋₂₀ alkyl group, p is an integer of from 0 to 3, and q is an integer of from 1 to 2.
